(19) United States
(12) Patent Application Publication
(10) Pub. No.: US 2022/0156349 A1
(43) Pub. Date: May 19, 2022

(54) AUTHENTICATION METHOD, AUTHENTICATION DEVICE, PROGRAM

(71) Applicant: NEC Corporation, Minato-ku, Tokyo (JP)

(72) Inventor: Hiroshi TSUKADA, Tokyo (JP)

(73) Assignee: NEC Corporation, Minato-ku, Tokyo (JP)

(21) Appl. No.: 17/439,081

(22) PCT Filed: Mar. 23, 2020
(86) PCT No.: PCT/JP2020/012641

§ 371 Date: Sep. 14, 2021

(30) Foreign Application Priority Data
Mar. 26, 2019 (JP) 2019-058384

(51) Int. Cl. G06F 21/31; G06T 7/40; G06V 10/422

(52) U.S. Cl. CPC G06F 21/31; G06F 2221/2117; G06V 10/422; G06T 7/40

(57) ABSTRACT

An authentication device 100 of the present invention includes a registration unit 121 and a collation unit 122. The registration unit 121 acquires person identification information for identifying a registration requesting person who requests registration of authentication information, and individual identification information with which an individual can be identified, the individual identification information using a surface pattern of an object from an object image for registration in which the object held by the registration requesting person is captured, and registers the person identification information and the individual identification information in association with each other as registration data. The collation unit 122 acquires the individual identification information of the object from an object image for authentication in which the object held by the authentication requesting person who requests authentication is captured, checks whether or not the individual identification information is registered in the registration data, and when the individual identification information is registered, acquires, from the registration data, the person identification information associated with the individual identification information in the registration data, as the person identification information of the authentication requesting person.

### TECHNICAL FIELD

The present invention relates to an authentication method, an authentication device, and a program.

### BACKGROUND ART

A system for performing authentication on a person, such as performing authentication on a person at the time of entering/leaving a room and allowing entering/leaving when the authentication succeeded, has been widely used. At that time, as authentication keys, a “password, a “card on which authentication information is recorded”, and “biological information” are widely used.

However, those used as authentication keys each have the shortcomings as described below, and have a problem that the usability thereof is not always suitable for users and operation managers.

In the case of a “password”, since it is a string of characters or numbers not familiar with the user, it is forgettable. On the contrary, if a familiar character string is used as a password, it is easily analogized by an attacker. In the case of a “card”, since the user may not always carry it, there is a possibility that the user does not have it in a scene where authentication is required. Moreover, since it is necessary to record authentication information on a card and issue it to a person to be authenticated, the cost placed on the operation manager increases. In the case of “biological information”, since the physical information of a person must be registered as authentication information, the personal information of the registrant will be leaked if the registration information is leaked. Moreover, as an input device, a special device for reading biological information is required, which causes a problem of an increase in the operation cost.

Patent Literature 1 discloses a case where a small article that is a property of a user is used as an authentication key. Specifically, from a captured image of a small article, the object is cut out and the positional shape feature of the small article is extracted, and authentication is performed by pattern matching with registered image data.

Patent Literature 1: JP 11-96120 A

### SUMMARY

However, in the method of Patent Literature 1, since authentication is performed according to matching/mismatching of the positional shape feature of a small article that is a property of a user, a problem of low authentication security is caused. For example, in the case where a small article is an industrial product, another small article of the same shape is sold.

Therefore, the registered small article may overlap with another person's one. Consequently, when a small article is used as an authentication key, a problem of lower authentication security is caused.

In view of above, an object of the present invention is to solve the aforementioned problems, that is, low authentication security and high operation cost.

An authentication method, according to one aspect of the present invention, is configured to include

acquiring person identification information for identifying a registration requesting person who requests registration of authentication information, and individual identification information with which an individual can be identified, the individual identification information using a surface pattern of an object from an object image for registration in which the object held by the registration requesting person is captured, and registering the person identification information and the individual identification information in association with each other as registration data; and

acquiring the individual identification information of the object from an object image for authentication in which the object held by the authentication requesting person who requests authentication is captured, checking whether or not the individual identification information is registered in the registration data, and when the individual identification information is registered, acquiring, from the registration data, the person identification information associated with the individual identification information in the registration data, as the person identification information of the authentication requesting person.

Further, an authentication device, according to one aspect of the present invention, is configured to include

a registration unit that acquires person identification information for identifying a registration requesting person who requests registration of authentication information, and individual identification information with which an individual can be identified, the individual identification information using a surface pattern of an object from an object image for registration in which the object held by the registration requesting person is captured, and registers the person identification information and the individual identification information in association with each other as registration data; and

a collation unit that acquires the individual identification information of the object from an object image for authentication in which the object held by the authentication requesting person who requests authentication is captured, checks whether or not the individual identification information is registered in the registration data, and when the individual identification information is registered, acquires, from the registration data, the person identification information associated with the individual identification information in the registration data, as the person identification information of the authentication requesting person.

Further, a program, according to one aspect of the present invention, is configured to cause an information processing device to realize:

a registration unit that acquires person identification information for identifying a registration requesting person who requests registration of authentication information, and individual identification information with which an individual can be identified, the individual identification information using a surface pattern of an object from an object image for registration in which the object held by the registration requesting person is captured, and registers the person identification information and the individual identification information in association with each other as registration data; and

a collation unit that acquires the individual identification information of the object from an object image for authentication in which the object held by the authentication requesting person who requests authentication is captured, checks whether or not the individual identification information is registered in the registration data, and when the individual identification information is registered, acquires, from the registration data, the person identification information associated with the individual identification information in the registration data, as the person identification information of the authentication requesting person.

With the configurations described above, the present invention enables the authentication security to be enhanced while suppressing an increase in the operation cost.

### BRIEF DESCRIPTION OF DRAWINGS

FIG. 1 is a block diagram illustrating a configuration of an authentication system according to a first exemplary embodiment of the present invention.

FIG. 2A illustrates an operation of the authentication system disclosed in FIG. 1.

FIG. 2B illustrates an operation of the authentication system disclosed in FIG. 1.

FIG. 2C illustrates an operation of the authentication system disclosed in FIG. 1.

FIG. 3A illustrates an operation of the authentication system disclosed in FIG. 1.

FIG. 3B illustrates an operation of the authentication system disclosed in FIG. 1.

FIG. 4 illustrates a state of processing by the authentication system disclosed in FIG. 1.

FIG. 5 illustrates a state of processing by the authentication system disclosed in FIG. 1.

FIG. 6 illustrates a state of processing by the authentication system disclosed in FIG. 1.

FIG. 7 illustrates a state of processing by the authentication system disclosed in FIG. 1.

FIG. 8 is a block diagram illustrating a hardware configuration of an authentication device according to a second exemplary embodiment of the present invention.

FIG. 9 is a block diagram illustrating a configuration of the authentication device according to the second exemplary embodiment of the present invention.

FIG. 10 is a flowchart illustrating an operation of the authentication device according to the second exemplary embodiment of the present invention.

### EXEMPLARY EMBODIMENTS

### First Exemplary Embodiment

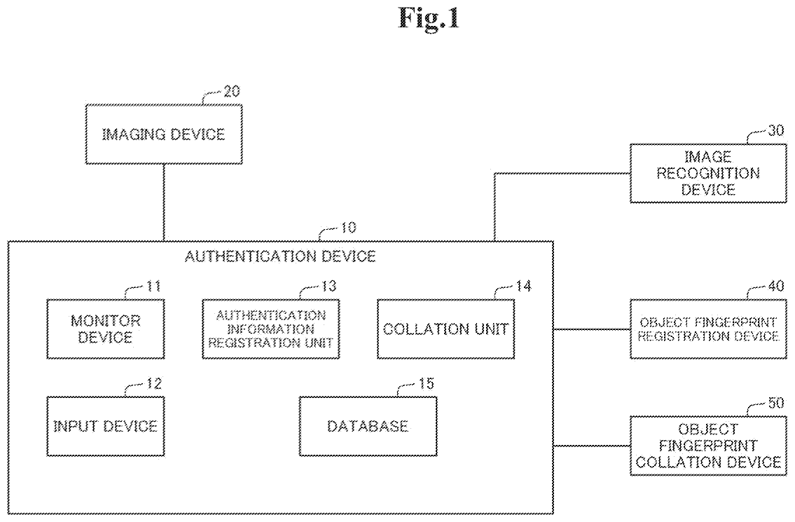

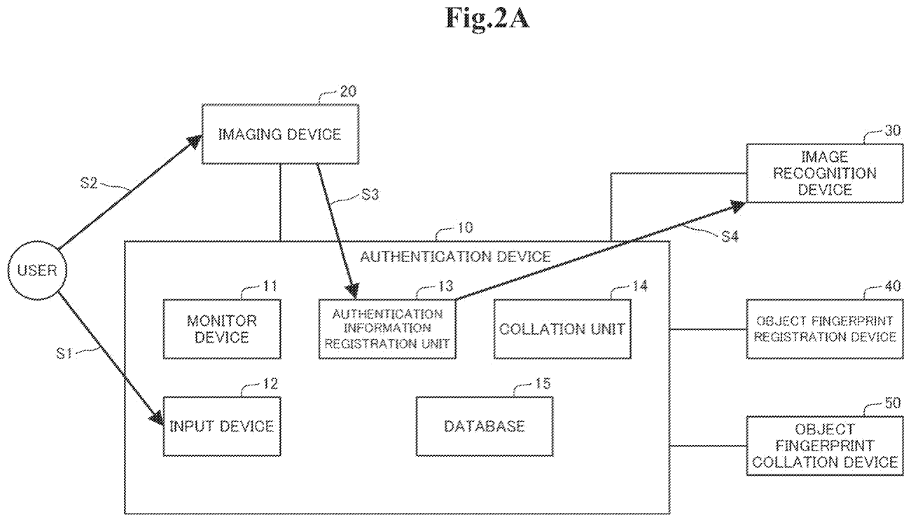

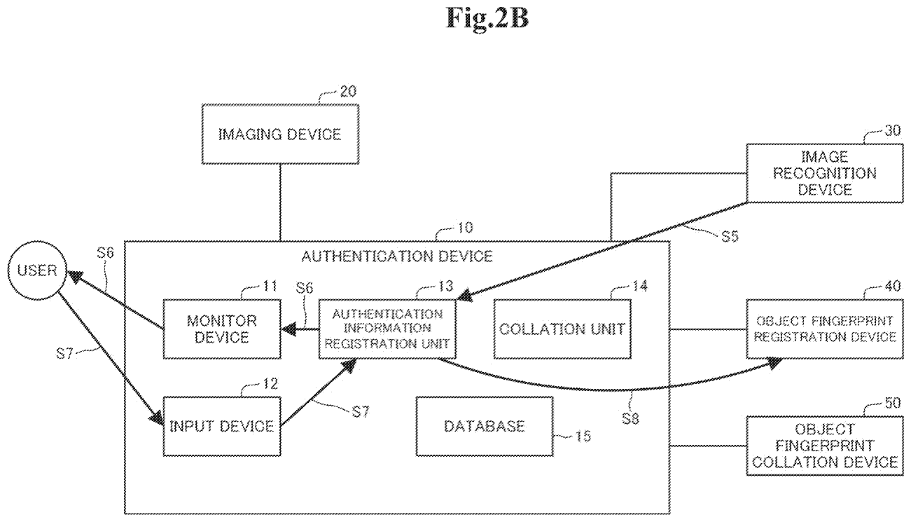

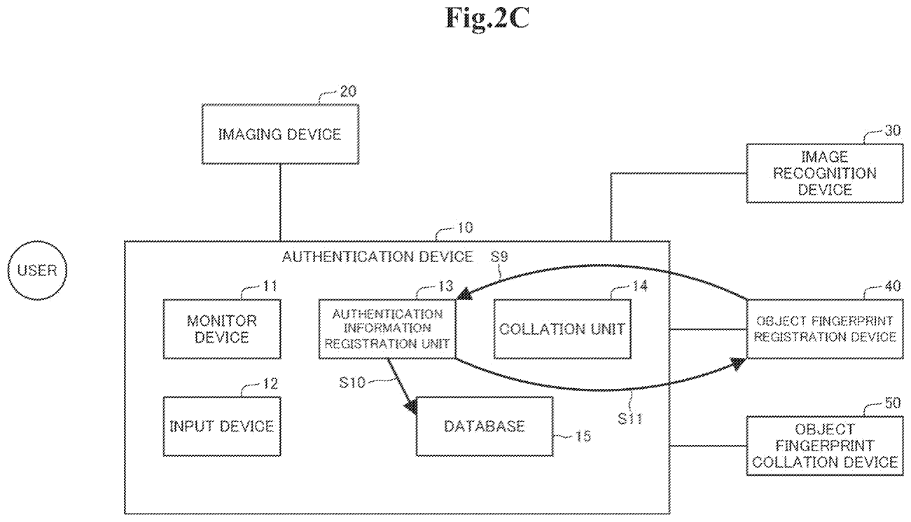

A first exemplary embodiment of the present invention will be described with reference to FIGS. 1 to 7. FIG. 1 is a diagram for explaining a configuration of an authentication system, and FIGS. 2A to 7 are illustrations for explaining the processing operation of the authentication system.

### [Configuration]

An authentication system of the present embodiment is an information processing system used for performing personal authentication on a person when entering or leaving a room and when starting use of a computer system. In particular, in the authentication system of the present embodiment, a general object such as a watch, a purse, or a ring owned by a person is used as an authentication key. In this method, an image of such an object is captured, and from the image data thereof, it is checked whether it matches an object registered as an authentication key, and authentication is performed. However, an object to be used as an authentication key is not limited to that described above, and any object may be used. Moreover, a scene in which authentication is performed is not limited to the above-described scene.

As illustrated in FIG. 1, the authentication system includes an authentication device 10, an imaging device 20, an image recognition device 30, an object fingerprint registration device 20, and an object fingerprint collation device 50. Hereinafter, configuration of each device will be described.

The authentication device 10 is configured of one or a plurality of image processing devices each having a monitor device 11, an input device 12, an arithmetic unit (not illustrated), and a storage unit (not illustrated). As illustrated in FIG. 1, the authentication device 10 includes an authentication information registration unit 13 and a collation unit 14 that are constructed by execution of a program by the arithmetic unit. The authentication device 10 also includes a database 15 formed in the storage device.

The input device 12 is a device used for inputting an operation when an operation by a user is required, in the authentication key registration step and the collation step described below. For example, the input device is a device such as a keyboard, a mouse, or a touch panel. The monitor device 11 is a device used for displaying information for operation on a screen when an operation by a user is required, in the authentication key registration step and the collation step described below.

The authentication information registration unit 13 (registration unit) stores, in the database 15, authentication subject information and an individual ID of an object to be used for authentication in association with each other. In particular, the authentication information registration unit 13 acquires an individual ID associated with the object fingerprint extracted from an object, and stores it together with the authentication subject information.

Specifically, the authentication information registration unit 13 first receives authentication subject information that is input via the input device 12, from a user who is a registration requesting person requesting registration of authentication information. For example, the authentication subject information is person identification information for identifying the user such as the name and the employee number of the user and a number automatically assigned by the authentication device 10.

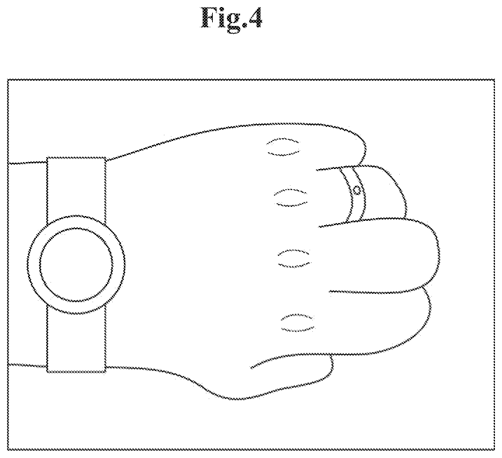

The authentication information registration unit 13 acquires image data (object image for registration) that is a still image of an object captured with use of the imaging device 20, from the user. At that time, the user captures an image of an object to be used for authentication. For example, in the case where an object to be used for authentication by the user is a “watch”, as illustrated in FIG. 4, the authentication information registration unit 13 acquires image data in which a hand (with a ring) of the user including the “watch” is captured.

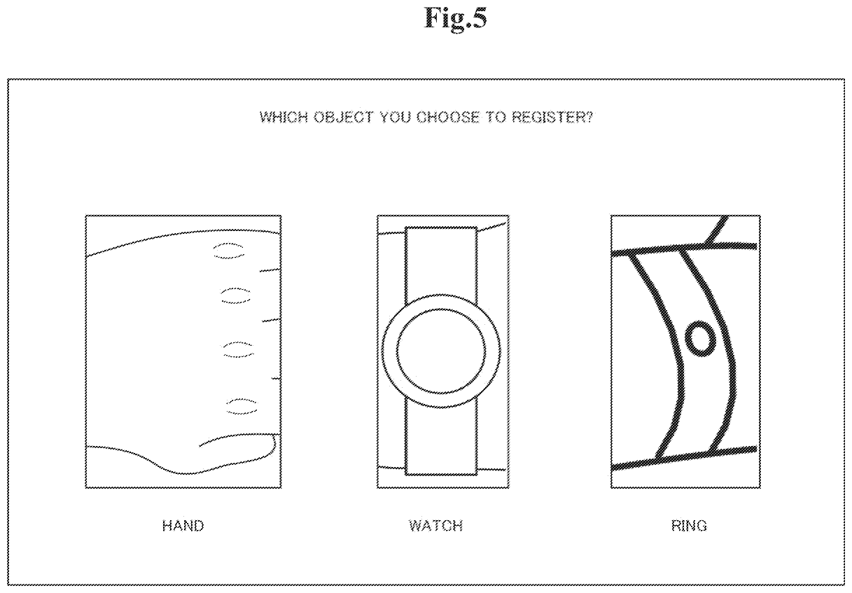

Then, the authentication information registration unit 13 sends the image data to the image authentication device 30, and for each object in the image data, receives information about the type, the position and the size thereof. In the example of FIG. 4 described above, “hand”, “watch”, and “ring” are detected as objects from the image data by the image authentication device 30. Then, the authentication information registration unit 13 cuts out the corresponding part of each object of the image data, on the basis of information about the type, the position, and the size of each object, and outputs the cutout image data of each object to be displayed on the monitor device 11. At that time, the authentication information registration unit 13 inquires of the user which object, among the objects, is to be used as an authentication key, as illustrated in FIG. 5. When only one object is detected from the image data, the authentication information registration unit 13 outputs cutout image data of the object as similar to the above-described case, and inquires of the user whether or not to register the object as an authentication key.

Here, the image recognition device 30 will be described. The image recognition device 30 is configured of one or a plurality of information processing devices each having an arithmetic unit and a storage unit. The image recognition device 30 implements the image recognition process described below through execution of a program by the arithmetic unit. Specifically, the image recognition device 30 is a device that receives image data from the authentication device 10, detects an object existing in the image data, and returns the type (hand, arm, watch, ring, or the like) of the object in the image and the position (coordinates, width, height) of the image. Note that when a plurality of objects exist in the image, the image recognition device 30 detects all of the objects and returns information thereof. Since the image recognition technique of the image recognition device 30 has been generalized and provided, the detailed description thereof is omitted.

When the authentication information registration unit 13 outputs the cutout image data of an object to be displayed to the user and inquires of the user an object to be registered as an authentication key, the authentication information registration unit 13 receives a response, input via the input device 12, from the user. That is, when displaying one object and making an inquiry, the authentication information registration unit 13 receives a response whether or not it is correct as an object to be registered, while when displaying a plurality of objects and making an inquiry, the authentication information registration unit 13 receives a response of one object selected to be registered. When only one object is detected from the image data, the authentication information registration unit 13 may automatically determine that such an object is an object to be registered. Meanwhile, when a plurality of objects are detected from the image data, the authentication information registration unit 13 may automatically determine any one of the objects to be an object to be registered. For example, that largest object may be determined to be an object to be registered.

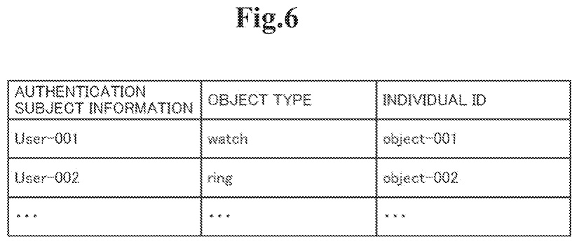

The authentication information registration unit 13 sends the cutout image data of the object to be registered to the object fingerprint registration device 40 according to a response from the user. Then, the authentication information registration unit 13 acquires, from the object fingerprint registration device 40, an individual ID associated with the feature amount extracted from the surface pattern (object fingerprint: individual identification information) of the object in the cutout image data. The authentication information registration unit 13 stores the acquired individual ID, the type (watch, ring, or the like) of the object, and the authentication subject information, as a set in the database 15 as illustrated in FIG. 6. That is, in the database 15, the authentication subject information and the individual ID that is an authentication key are stored in association with each other.

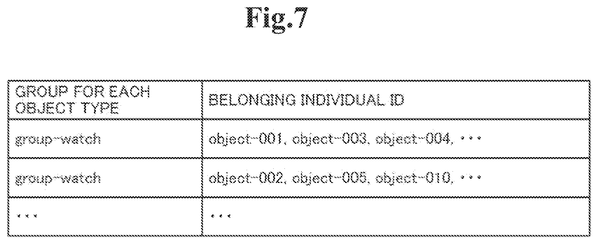

Further, the authentication information registration unit 13 requests the object fingerprint registration device 40 to allow the object of the individual ID registered in the database 15 to belong to a group of each object type. For example, in the case of the example of FIG. 5 described above, groups of “watch”, “ring”, and the like that are object types are generated, and for each of the groups, the authentication information registration unit 13 requests registration of individual IDs of the objects belonging thereto in association with one another. Thereby, in the object fingerprint registration device 40, individual IDs are stored in association with one another, for each of the groups representing the object types, as illustrated in FIG. 7.

Here, the object fingerprint registration device 40 will be described. The object fingerprint registration device 40 is configured of one or a plurality of information processing devices each having an arithmetic unit and a storage unit. The object fingerprint registration device 40 implements the object fingerprint registration process described below through execution of a program by the arithmetic unit. Specifically, the object fingerprint registration device 40 receives cutout image data from the authentication information registration unit 13 as described above, and calculates the feature amount from the state of the object surface included in the image data, that is, the object fingerprint. Note that the object fingerprint registration device 40 specifies the position (area) of the object surface from which the feature amount is calculated for each of the object types, in advance. For example, for an object of a particular type, the object fingerprint registration device 40 specifies that a position having a preset distance from a corner to be a position from which the feature amount is calculated. Thereby, for objects of the same type, the feature amount of the same position can be calculated. Then, the object fingerprint registration device 40 generates an individual ID for each object, stores it in association with the object ID and the object fingerprint (feature amount), and returns the individual ID to the authentication information registration unit 13.

Further, in response to a request from the authentication information registration unit 13, the object fingerprint registration device 40 generates a group for each object type, and for each group, registers the individual IDs of objects belonging thereto in association with one another. Thereby, as illustrated in FIG. 7, individual IDs are stored in association with one another, for each of the groups representing the object types.

As described above, as illustrated in FIG. 6, the authentication information registration unit 13 stores the authentication subject information, the individual ID, and the object type in association with one another in the database 15, and additionally, the individual ID is stored together with the feature amount of the object fingerprint in the object fingerprint registration device 40. Therefore, by cooperating with the image recognition device 30 and the object fingerprint registration device 40, the authentication information registration unit 13 acquires the authentication subject information corresponding to the person identification information of the user and the object fingerprint with which an object can be individually identifiable, and registers them as registration data in which they are associated with each other. Further, the individual ID is stored for each group of object type in the object fingerprint registration device 40. Therefore, the authentication information registration unit 13 registers the object fingerprint as registration data for each object type by cooperating with the image recognition device 30 and the object fingerprint registration device 40.

The collation unit 14 acquires the object ID shown in the image data to be used for collation, and checks whether or not the identical individual ID exists in the database 15. Then, when the identical individual ID exists in the database 15, the collation unit 14 acquires the authentication subject information associated with the individual ID and performs collation by using it as an authentication subject. For example, entering to or leaving from a room of a person requesting the collation is permitted.

Specifically, the collation unit 14 first acquires image data (object image for collation) that is a still image of an object captured with use of the imaging device 20, from the user to be collated who requests collation. At that time, the user captures an image of an object to be used for collation. For example, in the case where an object to be used for collation by the user is a “watch”, as illustrated in FIG. 4, the collation unit 14 acquires image data in which a hand (with a ring) of the user including the “watch” is captured.

Then, the collation unit 14 sends the image data to the image authentication device 30, and for each object in the image data, receives information about the type, the position, and the size thereof. In the example of FIG. 4 described above, “hand”, “watch”, and “ring” are detected as objects from the image data by the image authentication device 30. Then, the collation unit 14 cuts out the corresponding part of each object of the image data on the basis of the type, the position, and the size of each object, designates a group corresponding to the type of the object detected in the cutout image data, and sends the cutout image data to the object fingerprint collation device 50 and requests collation.

At that time, when a plurality of objects exist in the image data, the collation unit 14 outputs the cutout image data of each object to be displayed on the monitor device 11, inquires of the user which object is to be used for collation, and receive a choice of an object. When an object is selected in this way, or when only one object is detected from the beginning, collation is requested to the object fingerprint collation device 50 by designating the group corresponding to the object type. When a plurality of objects are detected from the image data, the authentication information registration unit 13 may automatically determine any one of the objects as an object to be collated, and request collation by designating the group corresponding to the type of the object. For example, the largest object maybe determined to be an object to be collated.

The collation unit 14 receives, from the object fingerprint collation device 50, an individual ID associated with object fingerprint having a high possibility of being identical to the object fingerprint (feature amount) of the object shown in the cutout image data. Then, the collation unit 14 checks the database 15 for the received individual DI, and acquires authentication subject information associated with the identical individual ID and performs collation.

Here, the object fingerprint collation device 50 will be described. The object fingerprint collation device 50 is configured of one or a plurality of information processing devices each having an arithmetic unit and a storage unit. The object fingerprint collation device 50 implements the object fingerprint collation process described below through execution of a program by the arithmetic unit. Specifically, the object fingerprint collation device 50 receives cutout image data from the collation unit 14 as described above, and calculates the feature amount from the object in the image data, similar to the object fingerprint registration device 40 described above. Note that the object fingerprint collation device 50 specifies the position (area) of the object surface from which the feature amount is calculated for each object type, in advance. For example, for an object of a particular type, the object fingerprint collation device 50 specifies a position having a preset distance from a corner to be a position from which the feature amount is calculated. Thereby, for objects of the same type, the feature amount of the same position can be calculated. Then, the object fingerprint collation device 50 determines whether or not the calculated feature amount has a high possibility that it matches any feature amount having been registered as registration data in the object fingerprint registration device 40, and returns the individual ID associated with the feature amount determined to have a high possibility to be matched , to the collation unit 14.

At that time, when the object fingerprint collation device 50 receives a designation of a group of the object type together with the cutout image data from the collation unit 14, the object fingerprint collation device 50 performs collation with the calculated feature amount only for the feature amount corresponding to the individual ID associated with the designated group in the registration data. Thereby, it is possible to reduce the number of pieces of collation targets for which the feature amount is collated, which enables high-speed collation.

As described above, the collation unit 14 cooperates with the image authentication device 30 and the object fingerprint collation device 50 to acquire the feature amount of the object fingerprint of the object shown in the image data for authentication, and acquires authentication subject information corresponding to the person identification information of the user associated with the object fingerprint in the registration data having a high possibility of being matched. At that time, the collation unit 14 cooperates with the image authentication device 30 and the object fingerprint collation device 50 to thereby perform collation on only the object fingerprint associated with the type of the object shown in the image data.

Here, the object fingerprint authentication technology provided by the object fingerprint registration device 40 and the object fingerprint collation device 50 as described above will be briefly described. In general, industrial products of the same specification are manufactured using manufacturing devices of the same specification so as not to have variations. However, even in mechanical components applied with cutting processing with high accuracy and components manufactured from the same mold, when the surfaces of the products are enlarged using a microscope under a specific illumination condition, the pieces of unevenness on the surfaces slightly differ from each other individually, which can be observed as different patterns. Such a fine pattern is of a level unrelated to the performance and the quality of a product and a component, and each has unique different feature. Therefore, the individual difference can be recognized by an image. That is, like a living thing, an industrial product also has a unique fingerprint individually, and it is possible to perform individual identification using such an object fingerprint.

Specifically, when an object fingerprint is extracted from a product, for example, a surface of a product is captured under a specific illumination condition, and from the captured image, a location where a change in the luminance is steep and the position is stably obtained is determined as a feature point. Then, by putting a local luminance pattern around the feature point into data as a feature amount, it is extracted as an object fingerprint of the product. Then, in the case of collating object fingerprints for checking whether or not they are identical products, it is performed by verifying consistency in the geometric arrangement of the feature points. For example, from the object fingerprints to be collated with each other, feature points in which the difference between the feature amounts becomes minimum is obtained as a pair, and from the obtained pair groups, only pair groups in which a relative positioning relationship with another feature point does not contradict are extracted. Then, a collation score S=ninlier/Ntotoal is calculated, where Ntotoal represents the number of extracted feature points, and ninlier represents the number of feature point pairs in which the geometric arrangement is correct. When the collation score is higher than a given threshold, it can be determined that the product from which the collated object fingerprint is extracted is an identical individual. Note that the object fingerprint extraction method and the collation method described above are just examples, and any methods may be used.

### [Operation]

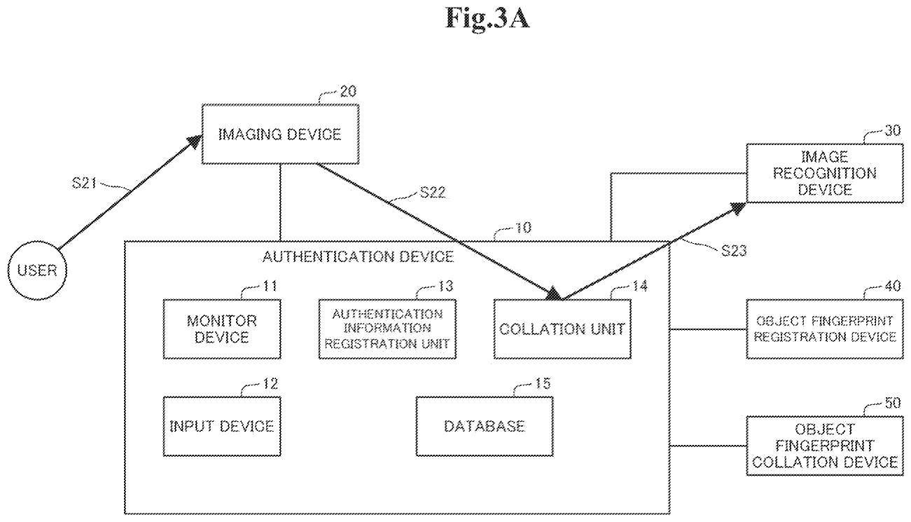

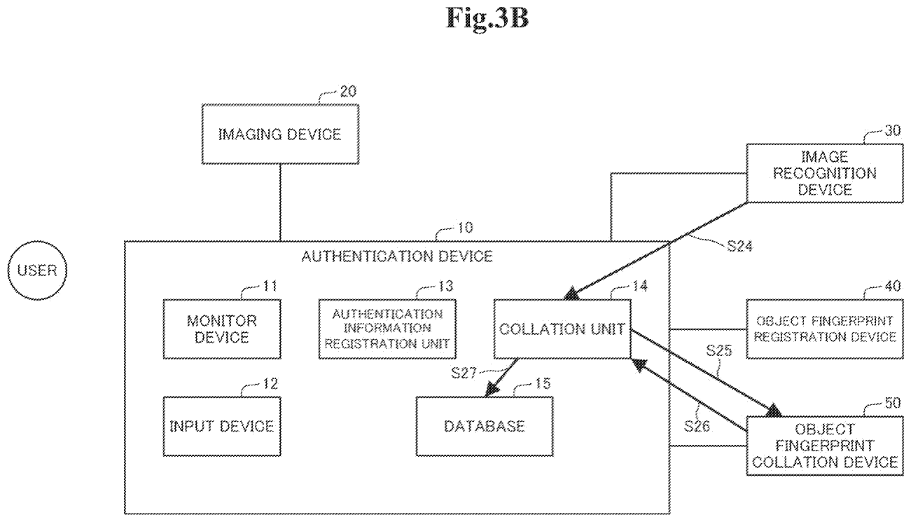

Next, operation of the authentication system as described above will be described with reference to FIGS. 2A to 3B mainly. First, with reference to FIGS. 2A to 2C, an operation in a registration step in which a user registers an object held by himself/herself as an authentication key will be described.

A user inputs authentication subject information to the authentication information registration unit 13 of the authentication device 10 by using the input device 12 (S1 of FIG. 2A). Along with it, the user captures an image of an object to be used for authentication by using the imaging device 20 (S2 of FIG. 2A). Here, it is assumed that an object to be used for authentication of the user is a “watch”, and that image data of a hand (with a ring) of the user including the “watch” is captured.

The imaging device 20 sends the captured image data of the object to the authentication information registration unit 13 of the authentication device 10 (S3 of FIG. 2A). Then, the authentication information registration unit 13 sends the image data to the image recognition device 30 (S4 of FIG. 2A). The image recognition device 30 recognizes the object included in the sent image data, determines what the object is and the size and the position of the object in the image, and returns such information to the authentication information registration unit 13 (S5 of FIG. 2B). For example, the image recognition device 30 recognizes the type of the object (hand, arm, watch, ring, or the like) existing in the image data, and the position of the object (coordinates, width, and height), and returns them.

From the information of the type, the position, and the size of the object sent from the image recognition device 30, the authentication information registration unit 13 displays a cutout image of the part corresponding to each object on the monitor device 11, and inquires of the user whether the object to be registered is correct (S6 of FIG. 2B). At this time, when a plurality of object images are detected from the image data, the authentication information registration unit 13 displays all of them on the monitor device 11, and inquires of the user which object is to be used as an authentication key. For example, in the exemplary image data of FIG. 4, images of the parts corresponding to the objects “hand”, “watch”, and “ring” are cut out, and are displayed on the monitor device 11 as illustrated in FIG. 5 for inquiry to the user. When only one object is detected from the image data, the authentication information registration unit 13 outputs cutout image data of the object as similar to the above-described case, and inquires of the user whether or not the object is a correct object to be registered as an authentication key.

The user inputs a response indicating whether or not the object displayed on the monitor device 11 is correct or a response indicating a choice from the objects to be used as an authentication key, with use of the input device 12 (S7 of FIG. 2B). The authentication information registration unit 13 receives a response from the user (S7 of FIG. 2B), and sends cutout image data of the object responded as correct from the user or the selected object, to the object fingerprint registration device 40 (S8 of FIG. 2B).

The object fingerprint registration device 40 calculates the feature amount from the surface information, that is, object fingerprint, of the object in the cutout image data sent from the authentication information registration unit 13. Further, the object fingerprint registration device 40 generates an individual ID, and stores the feature amount and the individual ID together in the object fingerprint registration device 40. Then, the object fingerprint registration device 40 returns the individual ID to the authentication information registration unit 13 (S9 of FIG. 2C).

The authentication information registration unit 13 stores the individual ID sent from the object fingerprint registration device 40, the type of the object (watch, ring, or the like), and the authentication subject information, as a set in the database 15 as illustrated in FIG. 6 (S10 of FIG. 2C). Further, the authentication information registration unit 13 requests the object fingerprint registration device 40 to allow the individual ID, registered along with the feature amount that is the object fingerprint in the object fingerprint registration device 40, to belong to the group of each object type (S11 of FIG. 2C). If there is no group corresponding to the object type, the object fingerprint registration device 40 creates a new group. Then, as illustrated in FIG. 7, the object fingerprint registration device 40 adds the individual ID to the group of each object type.

As described above, the authentication system acquires authentication subject information corresponding to person identification information of a user, and object fingerprint with which an object can be individually identifiable, and registers them in association with each other as registration data. At that time, the authentication system registers the object fingerprint associated with the individual ID as registration data for each object type.

Next, with reference to FIGS. 3A and 3B, an operation in a collation step for performing collation by using an object held by a user as an authentication key will be described.

A user captures an image of an object to be used for collation by using the imaging device 20 (S21 of FIG. 3A). Here, it is assumed that an object to be used for collation of the user is a “watch”, and that image data of a hand (with a ring) of the user including the “watch” is captured.

The imaging device 20 sends the captured image data of the object to the collation unit 14 of the authentication device 10 (S22 of FIG. 3A). Then, the collation unit 14 sends the image data to the image recognition device 30 (S23 of FIG. 3A). The image recognition device 30 recognizes the object included in the sent image data, determines what the object is and the position and the size of the object in the image, and returns such information to the collation unit 14 (S24 of FIG. 3B). For example, the image recognition device 30 recognizes the type of each object (hand, watch, ring, or the like) existing in the image data, and the position of the object (coordinates, width, and height), and returns them.

Similar to the registration step described above, by inquiring of the user the type of an object to be used as an authentication key and receiving a response, or automatically, the collation unit 14 specifies the type of one object, designates the group corresponding to the object type, and sends cutout image data to the object fingerprint collation device 50 and requests collation (S25 of FIG. 3B). The object fingerprint collation device 50 calculates the feature amount from the surface information, that is, object fingerprint, of the object in the sent image data. Then, the object fingerprint collation device 50 searches for an individual having a value close to the calculated feature amount, by using only the feature amounts of the objects belonging to the designated group as collation targets in the registered data registered by the object fingerprint registration device 40, acquires the individual ID, and returns it to the collation unit 14 (S26 of FIG. 3B).

The collation unit 14 acquires, from the database 15, authentication subject information associated with an individual ID that is identical to the individual ID sent from the collation device 50 (S27 of FIG. 3B). Then, the collation unit 14 performs collation on the basis of the acquired individual ID. For example, when the individual ID corresponding to the object fingerprint of the object shown in the image data for authentication is registered in the database 15, it is determined that the user is an authorized user, and the user is allowed to enter or leave.

As described above, in the authentication system, by registering the object fingerprint of an object held by a user, it is possible to use the object as an authentication key and perform collation. In this way, by using the object fingerprint with which an object can be individually identifiable as an authentication key, it is possible to improve the security of authentication and to suppress cost for required equipment. Further, since an object always carried by a user can be used as an authentication key, the risk of forgetting it when it is to be used is low. Furthermore, since it is a general object, if the registration information is leaked, it does not bring about leakage of personal information or authentication information.

Note that in the authentication system of the present invention, at the time of registration and collation of an object fingerprint of an object, registration and collation of the surrounding information of the object may be performed together with the feature amount of the object fingerprint. Thereby, it is possible to realize that authentication succeeds only when the angle of the object or how to hold it matches the registration information, for example. In the case where an object used for authentication is stolen, even though a person who stole it attempts to perform authentication using the object, authentication does not succeed if the holding state or the like differs from that is registered. Thereby, higher security can be realized.

### Second Exemplary Embodiment

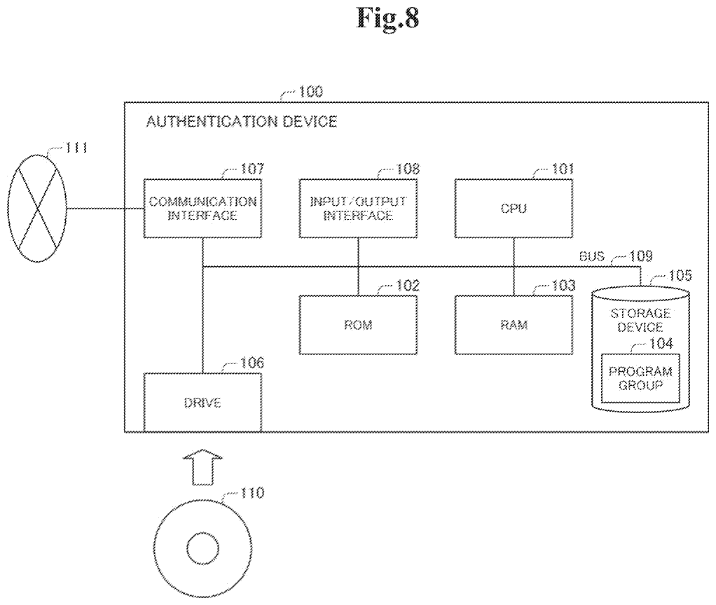

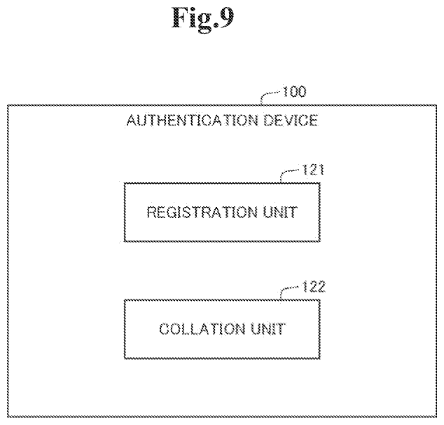

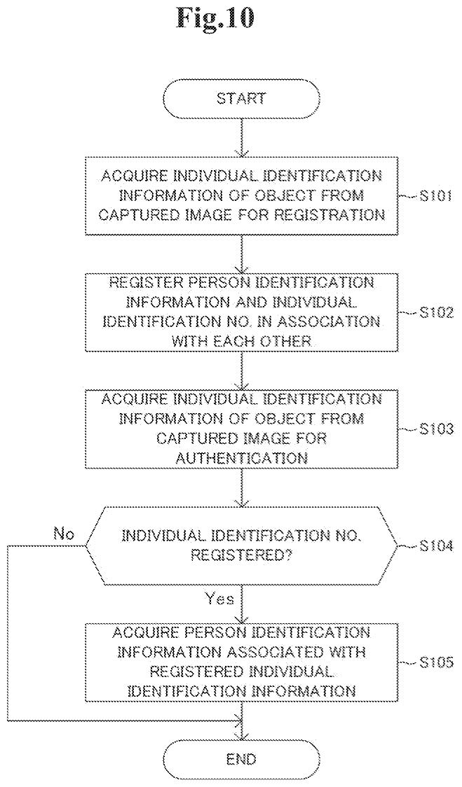

Next, a second exemplary embodiment of the present invention will be described with reference to FIGS. 8 to 10. FIGS. 8 and 9 are block diagrams illustrating a configuration of an authentication device of the second exemplary embodiment, and FIG. 10 is a flowchart illustrating the operation of the authentication device. Note that the present embodiment shows the outlines of the authentication system and the processing method performed by the authentication system described in the first exemplary embodiments.

First, a hardware configuration of the authentication device 100 in the present embodiment will be described with reference to FIG. 8. The authentication device 100 is configured of a typical information processing device, having a hardware configuration as described below as an example.
Central Processing Unit (CPU) 101 (arithmetic unit)
Read Only Memory (ROM) 102 (storage unit)
Random Access Memory (RAM) 103 (storage unit)
Program group 104 to be loaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the constituent elements

The authentication device 100 can construct, and can be equipped with, a registration unit 121 and a collation unit 122 illustrated in FIG. 9 through acquisition and execution of the program group 104 by the CPU 101. Note that the program group 104 is stored in the storage device 105 or the ROM 102 in advance, and is loaded to the RAM 103 by the CPU 101 as needed, for example. Further, the program group 104 may be provided to the CPU 101 via the communication network 111, or may be stored on the storage medium 110 in advance and read out by the drive 106 and supplied to the CPU 101. However, the registration unit 121 and the collation unit 122 may be constructed by electronic circuits.

Note that FIG. 8 illustrates an example of the hardware configuration of the information processing device that is the authentication device 100. The hardware configuration of the information processing device is not limited to that described above. For example, the information processing device may be configured of part of the configuration described above, such as without the drive 106.

The authentication device 100 executes the authentication method illustrated in the flowchart of FIG. 10, by the functions of the registration unit 121 and the collation unit 122 constructed by the program as described above.

As illustrated in FIG. 10, the authentication device 100

acquires person identification information for identifying a registration requesting person who requests registration of authentication information, and individual identification information with which an individual can be identified, the individual identification information using a surface pattern of an object from an object image for registration in which the object held by the registration requesting person is captured (step S101), and registers the person identification information and the individual identification information in association with each other as registration data (step S102), and

acquires the individual identification information of the object from an object image for authentication in which the object held by the authentication requesting person who requests the authentication is captured (step S103), checks whether or not the individual identification information is registered in the registration data (step S104), and when the individual identification information is registered (Yes at step S104), acquires, from the registration data, the person identification information associated with the individual identification information in the registration data, as the person identification information of the authentication requesting person (step S105).

Since the present invention is configured as described above, by registering the object fingerprint of an object held by a user, it is possible to use the object as an authentication key to perform collation. As described above, by using the object fingerprint with which an object can be individually identifiable as an authentication key, it is possible to improve the security of authentication and to suppress the cost for the required equipment.

Note that the program described above can be supplied to a computer by being stored in a non-transitory computer-readable medium of any type. Non-transitory computer-readable media include tangible storage media of various types. Examples of non-transitory computer-readable media include a magnetic storage medium (for example, flexible disk, magnetic tape, hard disk drive), a magneto-optical storage medium (for example, magneto-optical disk), a CD-ROM (Read Only Memory). a CD-R, a CD-R/W, and a semiconductor memory (for example, mask ROM, PROM (Programmable ROM), EPROM (Erasable PROM), a flash ROM, a RAM (Random Access Memory)). The program may also be supplied to a computer by being stored in a transitory computer-readable medium of any type. Examples of transitory computer-readable media include an electric signal, an optical signal, and an electromagnetic wave. A transitory computer-readable medium can be supplied to a computer via a wired communication channel such as a wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

The present invention is based upon and claims the benefit of priority from Japanese patent application No. 2019-058384, filed on Mar. 26, 2019, the disclosure of which is incorporated herein in its entirety by reference.

### <Supplementary Notes>

The whole or part of the exemplary embodiments disclosed above can be described as the following supplementary notes. Hereinafter, outlines of the configurations of an authentication method, an authentication device, and a program, according to the present invention, will be described. However, the present invention is not limited to the configurations described below.

### (Supplementary Note 1)

An authentication method comprising:

acquiring person identification information for identifying a registration requesting person who requests registration of authentication information, and individual identification information with which an individual can be identified, the individual identification information using a surface pattern of an object from an object image for registration in which the object held by the registration requesting person is captured, and registering the person identification information and the individual identification information in association with each other as registration data; and

acquiring the individual identification information of the object from an object image for authentication in which the object held by the authentication requesting person who requests authentication is captured, checking whether or not the individual identification information is registered in the registration data, and when the individual identification information is registered, acquiring, from the registration data, the person identification information associated with the individual identification information in the registration data, as the person identification information of the authentication requesting person.

### (Supplementary Note 2)

The authentication method according to supplementary note 1, further comprising:

registering the person identification information acquired from the object image for registration as the registration data for each given group; and

with respect to the individual identification information registered in the registration data corresponding to a designated group, checking whether or not the individual identification information acquired from the object image for authentication is registered in the registration data.

### (Supplementary Note 3)

The authentication method according to supplementary note 1 or 2, further comprising:

detecting, from the object image for registration, a type of the object shown in the object image for registration, and registering the individual identification information for each type of the object as the registration data; and

detecting, from the object image for authentication, a type of the object shown in the object image for authentication, and with respect to the individual identification information registered in the registration data corresponding to the detected type of the object, checking whether or not the individual identification information acquired from the object image for authentication is registered in the registration data.

### (Supplementary Note 4)

The authentication method according to any of supplementary notes 1 to 3, further comprising

when a plurality of objects shown in the object image for registration are detected from the object image for registration, acquiring the individual identification information of one selected object, and registering the person identification information and the individual identification information in association with each other as the registration data.

### (Supplementary Note 5)

The authentication method according to supplementary note 4, further comprising:

when a plurality of objects shown in the object image for registration are detected from the object image for registration, outputting images of the plurality of the objects to the registration requesting person, acquiring the individual identification information of one of the objects selected by the registration requesting person, and registering the person identification information and the individual identification information in association with each other as the registration data.

### (Supplementary Note 6)

The authentication method according to any of supplementary notes 1 to 5, further comprising

when a plurality of objects shown in the object image for authentication are detected from the object image for authentication, acquiring the individual identification information of one selected object, and checking whether or not the individual identification information is registered in the registration data.

### (Supplementary Note 7)

The authentication method according to supplementary note 6, further comprising:

when a plurality of objects shown in the object image for authentication are detected from the object image for authentication, outputting images of the plurality of the objects to the authentication requesting person, acquiring the individual identification information of one of the objects selected by the authentication requesting person, and checking whether or not the individual identification information is registered in the registration data.

### (Supplementary Note 8)

An authentication device comprising:

a registration unit that acquires person identification information for identifying a registration requesting person who requests registration of authentication information, and individual identification information with which an individual can be identified, the individual identification information using a surface pattern of an object from an object image for registration in which the object held by the registration requesting person is captured, and registers the person identification information and the individual identification information in association with each other as registration data; and

a collation unit that acquires the individual identification information of the object from an object image for authentication in which the object held by the authentication requesting person who requests authentication is captured, checks whether or not the individual identification information is registered in the registration data, and when the individual identification information is registered, acquires, from the registration data, the person identification information associated with the individual identification information in the registration data, as the person identification information of the authentication requesting person.

### (Supplementary Note 8.1)

The authentication device according to supplementary note 8, wherein

the registration unit registers the person identification information acquired from the object image for registration as the registration data for each given group, and

with respect to the individual identification information registered in the registration data corresponding to a designated group, the collation unit checks whether or not the individual identification information acquired from the object image for authentication is registered in the registration data.

### (Supplementary Note 8.2)

The authentication device according to supplementary note 8 or 8.1, wherein

the registration unit detects, from the object image for registration, a type of the object shown in the object image for registration, and registers the individual identification information for each type of the object as the registration data, and

the collation unit detects, from the object image for authentication, a type of the object shown in the object image for authentication, and with respect to the individual identification information registered in the registration data corresponding to the detected type of the object, checks whether or not the individual identification information acquired from the object image for authentication is registered in the registration data.

### (Supplementary Note 8.3)

The authentication device according to any of supplementary notes 8 to 8.2, wherein

when the registration unit detects a plurality of objects shown in the object image for registration from the object image for registration, the registration unit acquires the individual identification information of one selected object, and registers the person identification information and the individual identification information in association with each other as the registration data.

### (Supplementary Note 8.4)

The authentication device according to claim 8.3, wherein

when the registration unit detects a plurality of objects shown in the object image for registration from the object image for registration, the registration unit outputs images of the plurality of the objects to the registration requesting person, acquires the individual identification information of one of the objects selected by the registration requesting person, and registers the person identification information and the individual identification information in association with each other as the registration data.

### (Supplementary Note 8.5)

The authentication device according to any of supplementary notes 8 to 8.4, wherein

when the collation unit detects a plurality of objects shown in the object image for authentication from the object image for authentication, the collation unit acquires the individual identification information of one selected object, and checks whether or not the individual identification information is registered in the registration data.

### (Supplementary Note 8.6)

The authentication device according to supplementary note 8.5, wherein

when the collation unit detects a plurality of objects shown in the object image for authentication from the object image for authentication, the collation unit outputs images of the plurality of the objects to the authentication requesting person, acquires the individual identification information of one of the objects selected by the authentication requesting person, and checks whether or not the individual identification information is registered in the registration data.

### (Supplementary Note 9)

A program for causing an information processing device to realize:

a registration unit that acquires person identification information for identifying a registration requesting person who requests registration of authentication information, and individual identification information with which an individual can be identified, the individual identification information using a surface pattern of an object from an object image for registration in which the object held by the registration requesting person is captured, and registers the person identification information and the individual identification information in association with each other as registration data; and

a collation unit that acquires the individual identification information of the object from an object image for authentication in which the object held by the authentication requesting person who requests authentication is captured, checks whether or not the individual identification information is registered in the registration data, and when the individual identification information is registered, acquires, from the registration data, the person identification information associated with the individual identification information in the registration data, as the person identification information of the authentication requesting person.

### REFERENCE SIGNS LIST

10 authentication device
11 monitor device
12 input device
13 authentication information registration unit
14 collation unit
15 database
20 imaging device
30 image recognition device
40 object fingerprint registration device
50 object fingerprint collation device
100 authentication device
101 CPU
102 ROM
103 RAM
104 program group
105 storage device
106 drive
107 communication interface
108 input/output interface
109 bus
110 storage medium
111 communication network
121 registration unit
122 collation unit

What is claimed is:

1. An authentication method comprising:
acquiring person identification information for identifying a registration requesting person who requests registration of authentication information, and individual identification information with which an individual can be identified, the individual identification information using a surface pattern of an object from an object image for registration in which the object held by the registration requesting person is captured, and registering the person identification information and the individual identification information in association with each other as registration data; and
acquiring the individual identification information of the object from an object image for authentication in which the object held by the authentication requesting person who requests authentication is captured, checking whether or not the individual identification information is registered in the registration data, and when the individual identification information is registered, acquiring, from the registration data, the person identification information associated with the individual identification information in the registration data, as the person identification information of the authentication requesting person.

2. The authentication method according to claim 1, further comprising:
registering the person identification information acquired from the object image for registration as the registration data for each given group; and
with respect to the individual identification information registered in the registration data corresponding to a designated group, checking whether or not the individual identification information acquired from the object image for authentication is registered in the registration data.

3. The authentication method according to claim 1, further comprising:
detecting, from the object image for registration, a type of the object shown in the object image for registration, and registering the individual identification information for each type of the object as the registration data; and
detecting, from the object image for authentication, a type of the object shown in the object image for authentication, and with respect to the individual identification information registered in the registration data corresponding to the detected type of the object, checking whether or not the individual identification information acquired from the object image for authentication is registered in the registration data.

4. The authentication method according to claim 1, further comprising
when a plurality of objects shown in the object image for registration are detected from the object image for registration, acquiring the individual identification information of one selected object, and registering the person identification information and the individual identification information in association with each other as the registration data.

5. The authentication method according to claim 4, further comprising:
when a plurality of objects shown in the object image for registration are detected from the object image for registration, outputting images of the plurality of the objects to the registration requesting person, acquiring the individual identification information of one of the objects selected by the registration requesting person, and registering the person identification information and the individual identification information in association with each other as the registration data.

6. The authentication method according to claim 1, further comprising
when a plurality of objects shown in the object image for authentication are detected from the object image for authentication, acquiring the individual identification information of one selected object, and checking whether or not the individual identification information is registered in the registration data.

7. The authentication method according to claim 6, further comprising:
when a plurality of objects shown in the object image for authentication are detected from the object image for authentication, outputting images of the plurality of the objects to the authentication requesting person, acquiring the individual identification information of one of the objects selected by the authentication requesting person, and checking whether or not the individual identification information is registered in the registration data.

8. An authentication device comprising:
at least one memory configured to store instructions; and
at least one processor configured to execute instructions to:
acquire person identification information for identifying a registration requesting person who requests registration of authentication information, and individual identification information with which an individual can be identified, the individual identification information using a surface pattern of an object from an object image for registration in which the object held by the registration requesting person is captured, and register the person identification information and the individual identification information in association with each other as registration data; and
acquire the individual identification information of the object from an object image for authentication in which the object held by the authentication requesting person who requests authentication is captured, check whether or not the individual identification information is registered in the registration data, and when the individual identification information is registered, acquire, from the registration data, the person identification information associated with the individual identification information in the registration data, as the person identification information of the authentication requesting person.

9. The authentication device according to claim 8, wherein the at least one processor is configured to execute the instructions to:
register the person identification information acquired from the object image for registration as the registration data for each given group; and
with respect to the individual identification information registered in the registration data corresponding to a designated group, check whether or not the individual identification information acquired from the object image for authentication is registered in the registration data.

10. The authentication device according to claim 8, wherein the at least one processor is configured to execute the instructions to:
detect, from the object image for registration, a type of the object shown in the object image for registration, and register the individual identification information for each type of the object as the registration data, and
detect, from the object image for authentication, a type of the object shown in the object image for authentication, and with respect to the individual identification information registered in the registration data corresponding to the detected type of the object, check whether or not the individual identification information acquired from the object image for authentication is registered in the registration data.

11. The authentication device according to claim 8, wherein the at least one processor is configured to execute the instructions to,
when a plurality of objects shown in the object image for registration are detected from the object image for registration, acquire the individual identification information of one selected object, and register the person identification information and the individual identification information in association with each other as the registration data.

12. The authentication device according to claim 11, wherein the at least one processor is configured to execute the instructions to,
when a plurality of objects shown in the object image for registration are detected from the object image for registration, output images of the plurality of the objects to the registration requesting person, acquire the individual identification information of one of the objects selected by the registration requesting person, and register the person identification information and the individual identification information in association with each other as the registration data.

13. The authentication device according to claim 8, wherein the at least one processor is configured to execute the instructions to,
when a plurality of objects shown in the object image for authentication are detected from the object image for authentication, acquire the individual identification information of one selected object, and check whether or not the individual identification information is registered in the registration data.

14. The authentication device according to claim 13, wherein the at least one processor is configured to execute the instructions to,
when a plurality of objects shown in the object image for authentication are detected from the object image for authentication, the collation unit output images of the plurality of the objects to the authentication requesting person, acquire the individual identification information of one of the objects selected by the authentication requesting person, and check whether or not the individual identification information is registered in the registration data.

15. A non-transitory computer-readable storage medium in which a program is stored, the program comprising instructions for causing an information processing device to execute processing to:
acquire person identification information for identifying a registration requesting person who requests registration of authentication information, and individual identification information with which an individual can be identified, the individual identification information using a surface pattern of an object from an object image for registration in which the object held by the registration requesting person is captured, and register the person identification information and the individual identification information in association with each other as registration data; and
acquire the individual identification information of the object from an object image for authentication in which the object held by the authentication requesting person who requests authentication is captured, check whether or not the individual identification information is registered in the registration data, and when the individual identification information is registered, acquire, from the registration data, the person identification information associated with the individual identification information in the registration data, as the person identification information of the authentication requesting person.
